(19) United States
(12) Patent Application Publication
(10) Pub. No.: US 2012/0110647 A1
(43) Pub. Date: May 3, 2012

(54) MANAGING UNIQUELY TAGGED ITEMS USING THE INTERNET

(75) Inventors: Qi Guo, Beijing (CN); Jian Li, Beijing (CN); Xing Xing Shen, Beijing (CN); Yun Wang, Beijing (CN); Jia Tian Zhong, Beijing (CN)

(73) Assignee: INTERNATIONAL BUSINESS MACHINES CORPORATION, Armonk, NY (US)

(21) Appl. No.: 13/277,775

(22) Filed: Oct. 20, 2011

(30) Foreign Application Priority Data
Oct. 29, 2010 (CN) 201010524764.2

(51) Int. Cl. H04L 9/32; G06F 17/30

(52) U.S. Cl. 726/4; 707/736; 707/E17.014

(57) ABSTRACT

The invention teaches managing an item in the Internet of Things, wherein the system comprises: an item registration module, configured to receive at least one registration information of the item, wherein the registration information of the item includes the item's unique number marked by an information sensing device and a tag of an external data source where related information of the item is located, the at least one registration information is from at least one external data source, the unique number is the same in the at least one registration information; a storage module, configured to store the item's registration information; and a query processing module, configured to receive a query to the related information of the item, and obtain the related information of the item from the external data source which corresponds to the external data source tag included in the stored registration information of the item.

### TECHNICAL FIELD

Embodiments of the present invention generally relate to management of an item and attributes thereof in the Internet of Things (IOT), and in particular, to a method and system for managing an item in the Internet of Things.

### BACKGROUND ART

The concept of the “Internet of Things” is a network concept on the basis of “Internet concept”, where user terminals therein are extended and expanded to among any items for information exchange and communication. The definition of the Internet of Things (hereinafter as IOT) is a network concept, which connects any item with the Internet via an information sensing device such as Radio Frequency IDentification (RFID), an infrared sensor, Global Position System (GPS), a laser scanner and so on, according to protocols of the agreement, for information exchange and communication, in order to achieve intelligent identification, location, tracking, monitoring and management.

The items in the IOT have attributes, for example, a garment having many attributes such as color, material, price, brand, a washing requirement and so on. Each item could have many different types of attributes, which are normally maintained by different vendors during a lifetime of the item. In addition, the item could have many other attributes, which may be maintained by the owner or other companies or divisions; such information is distributed among different places while each place has its own information control manner, and it is very difficult to get such information for the IOT application or persons going to get the information.

Therefore, how to manage the information of the item in the IOT is necessary.

### SUMMARY OF THE INVENTION

Thus, there is a need for a method and system for effectively managing an item in the IOT, so as to make easier management and access to the item's information in the IOT. The present invention provides such a method and system.

According to one aspect of the present invention, there is provided a system for managing an item in the Internet of Things, comprising:

an item registration module, configured to receive at least one registration information of the item, wherein the registration information of the item includes the item's unique number marked by an information sensing device and a tag of an external data source where related information of the item is located, the at least one registration information is from at least one external data source, the unique number is the same in the at least one registration information;

a storage module, configured to store the item's registration information; and

a query processing module, configured to receive a query to the related information of the item, and obtain the related information of the item from the external data source which corresponds to the external data source tag included in the stored registration information of the item.

According to another aspect of the present invention, there is provided a method for managing an item in the Internet of Things, comprising:

receiving at least one registration information of the item, wherein the registration information of the item includes the item's unique number marked by an information sensing device and a tag of an external data source where related information of the item is located, the at least one registration information is from at least one external data source, the unique number is the same in the at least one registration information;

storing the item's registration information; and

receiving a query to the related information of the item;

obtaining the related information of the item from the external data source which corresponds to the external data source tag included in the stored registration information of the item.

### BRIEF DESCRIPTION OF THE DRAWINGS

The above and other purposes, features and advantages of the present invention will become more apparent from more detailed description of exemplary embodiments of the present invention illustrated in accompanying drawings, in which like reference numerals normally represent like parts of the exemplary embodiments of the present invention.

FIG. 1 illustrates a diagram of a structure of a system for managing an item in the IOT according to an embodiment of the present invention;

FIG. 2 illustrates a table structure of an item table storing all registration information;

FIG. 3 illustrates a table structure for storing registration information by using a plurality of tables; and

FIG. 4 illustrates a flowchart of a method of managing an item in the IOT according to an embodiment of the present invention.

### DETAILED DESCRIPTION OF THE PREFERRED EMBODIMENTS

The preferred embodiments of the present invention will be described in more detailed with reference to the accompanying drawings, in which the preferred embodiments of the present invention are illustrated. The present invention may, however, be implemented in various forms and should not be construed as being limited to the embodiments set forth herein. Rather, these embodiments are provided to make the invention more thorough and complete, and to fully convey the scope of the invention to those skilled in the art.

The item in the IOT are marked by using an information sensing device, including a Radio-Frequency Identification (RFID) tag, an infrared sensor, GPS, a laser scanner and so on, the current RFID technology has enabled the item globally unique, for example, a coding system of the EPC compatible with the EAN-UCC coding system can enable the RF tag globally unique.

After the item is identified uniquely, during the lifetime of the item, a plurality of vendors maintain different attribute information of the item by using different databases. Taken a garment as a example of the item in the IOT, the attribute information of the garment includes producing area, production date, lot number, color, a washing requirement and so on during a stage of production, which are stored and maintained by a manufacturer; when the item enters into a sale stage, the attribute information thereof includes retailer, purchase price, sale price, discount activity involved, shopping mall area where a good is located and so on, which are stored and maintained by a retailer; after the item has been purchased by a user, the user can also maintain a group of attribute information such as a user purchase time, a user purchase price, a washing way of the item preferred by the user, an occasion to wear the item preferred by the user and so on, according to his/her preference, which are stored and maintained by the user oneself. In practice, a network provider can provide a certain storage area for each user so that the user can store the attribute information of the item interested by the user oneself.

When the item is delivered to a dry cleaning shop by the user, if a washing machine of the dry cleaning shop can identify the information sensing device attached to the item, such as the Radio-Frequency Identification (RFID) tag, it can obtain the washing requirement of the item and the washing way of the item preferred by the user to thereby determine how to wash the item. If the item is damaged due to a washing quality, compensation can be negotiated by the user purchase time, the user purchase price, or the sale price of the item during the compensation. However, although the dry cleaning machine of the dry cleaning shop can access the information sensing device (e.g. RFID) of the item and obtain the unique identification number of the item, it is difficult to get the different attribute information required by a simple manner since they are stored in databases of the different vendors.

The present invention proposes a system for managing an item in the IOT, and FIG. 1 illustrates a diagram of a structure of a system 100 for managing an item in the IOT according to an embodiment of the present invention. According to FIG. 1, the system 100 includes an item registration module 101, a storage module 102 and query processing module 103.

The item registration module 101 is configured to receive at least one registration information of the item, of which the registration information may come from different data sources, for example, in the example of the garment item mentioned above, the unique number (ID) of the item is included among a data source module maintained by a manufacturer, a data source module maintained by a retailer and a data source module of the item information maintained by a user, therefore, the at least one registration information is from at least one external data source, and the unique number is the same in the at least one registration information. The respective data sources can register the unique number of the item, an external data source tag storing the item information in the system 100 through the item registration module 101, therefore, the registration information of the item includes the unique number of the item marked by an information sensing device and the external data source where the related information of the item is located. The external data source can be expressed as an IP address of the external data source, and can also be expressed as a link of the external data source, or any other tags to find the external data source therefrom. Preferably, the registration information further includes: an IP address of the external data source where the related information of the item is located, and an attribute of the item stored by the external data source. In a preferred embodiment, in order to save a communication bandwidth, can also be only registered the external data source storing the item information, a range of the unique number of the stored item and the attribute of the item stored by the external data source, and it is not necessary to register the attribute information of a particular item. Such manner can significantly reduce an amount of communication information for the registration where the manufacturer produces a number of products of a same type whose attribute ranges are exactly identical. Further, the external data source can communicate with the item registration module to register more information on the item, for example, can also register a role of a registrant (e.g. the manufacturer, the retailer or a consumer), a valid time of the information, which users the information can be exposed to, notes for using the information, a permission to use the information and so on. The registration information of the item can also be from an input of a user interface. The item registration module 101 can provide a program interface for the external data source, and a user directly links the external data source to the item registration module through programming to directly register the item data; also it can provide the user interface to perform a manual registration of the item and so on. The system may perform a large amount of interactions with the item, thus preferably, the system also includes a read device of the information sensing device to receive the unique number of the item. In a manner of the manual registration, the item registration module is the read device through the information sensing device, which reads the unique number of the item to simplify the input manner.

There is a problem whether the item registration information of the system is trustful; therefore, preferably, the system further includes a data source authentication module configured to authenticate the authenticity of the external data source included in the registration information of the item before storing the registration information of the item. the existing authentication technologies can be adopted, for example, a simple one is to adopt the registration by a data source name and a password, and a complex one is to adopt public key authentication, a third party authentication, etc.

The storage module 102 stores the registration information of the item. The storage module 102 can perform the storage by using a flexible storing mode, for example, it can use a relationship type database for storing, or it can also use a semi-structured XML mode for storing.

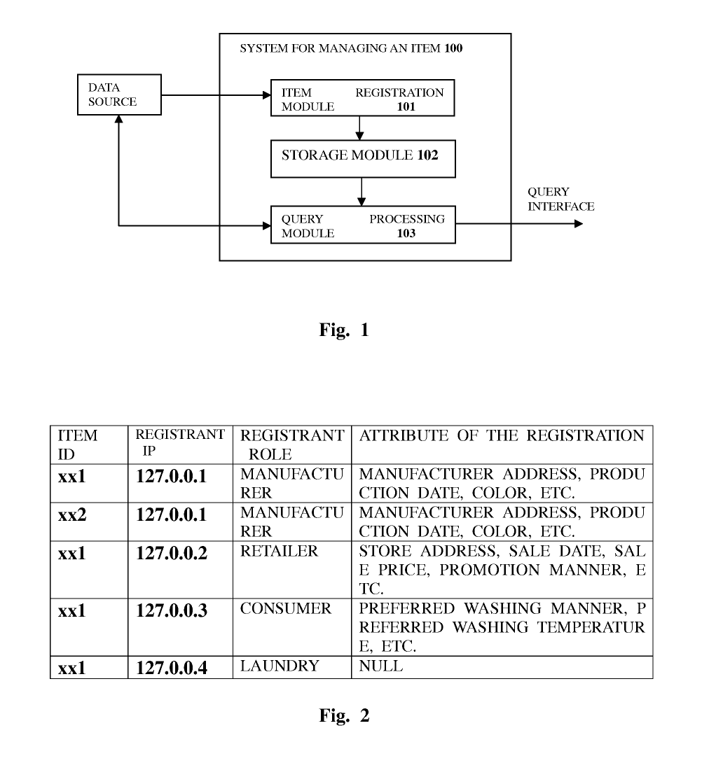

In a manner of using the relationship type database for storing, an embodiment is to store all the registration information by using one item table; and FIG. 2 illustrates a table structure of the item table storing all the registration information, wherein if the data source further registers other information, it can be implemented by adding more columns into the table of FIG. 2.

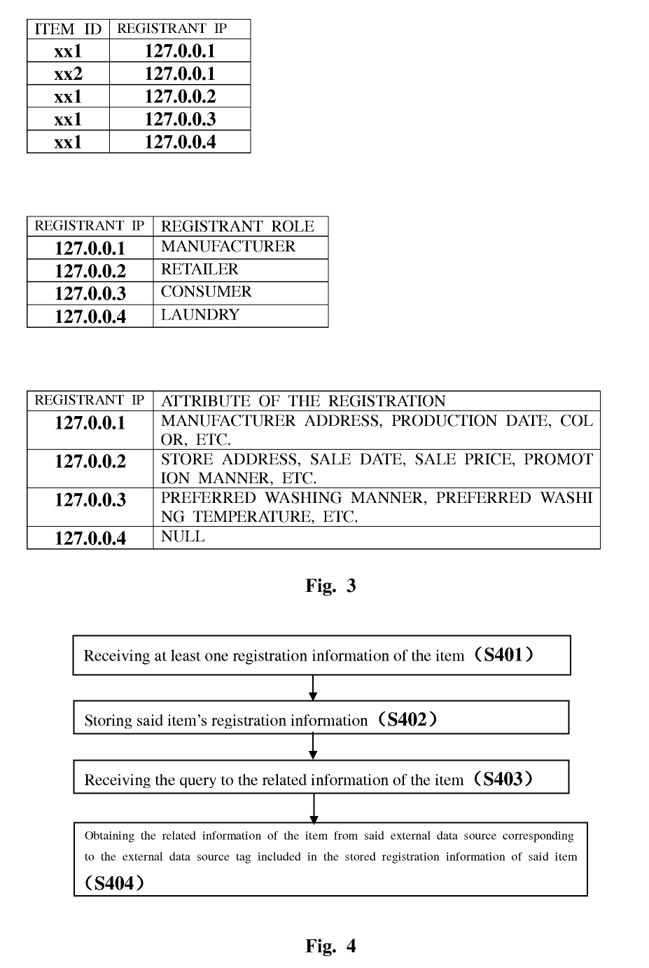

In a manner of using the relationship type database for storing, another embodiment is to perform the storage by using a plurality of tables so as to save storage space, and for example, FIG. 3 illustrates a table structure for storing the registration information by using a plurality of tables. As shown in FIG. 3, for the same registration information as shown in FIG. 2, three tables as shown in FIG. 3 can be adopted to store the registration information such that the storage space can be saved.

In a manner of using XML mode for storing, a type of XML Schema is schematically defined as follows,

```
<ITEM>
  <item ID VALUE=‘XX1’ registration IP=‘123’ registrant=‘*PROD’>
    <METADATA>
      <color/>
      <MATERIAL/>
          ......
    </METADATA>
  </item ID >
  ......
</ITEM>
```

The skilled in the art can define a suitable XML Schema according to the requirement to meet a suitable requirement.

The query processing module 103 receives a query for the related information of the item, and obtains the related information of the item from the external data source which corresponds to the external data source tag included in the stored registration information of the item. The related information of the item is normally included in the registration information of the item and/or in the information of the external data source, for example, the item garment is registered an attribute “color”, but the registration information only comprises the registered attribute information of the item, and does not comprises an attribute value of the item. The specific attribute value is located in the external data source, and such attribute value information belongs to the related information of the registration information. In a preferred embodiment, in the query processing module, the received query for the related information of the item includes the attribute information of the item, obtaining the related information of the item from the external data source includes obtaining the related information of the item from the IP address of the external data source registering the attribute information of the item based on the attribute information of the above item. The query processing module 103 can negotiate with the external data source, and carry out the query for the related information of the item according to the negotiated program interface; and the query processing module 103 can also provide a program interface for a query user, or provide a user interface for the query user in order to input query by the user. As for an example of query by using the table structure of the database of table 1 (assuming the name of the database is DATACENTER, the name of the table is ITEMINFO), query statements can be:

SELECT IP FROM DATACENTER.ITEMINFO
WHERE item ID=‘XX1’
AND registered attribute CONTAINS(‘color’)
AND registrant role=‘manufacturer’

After obtaining a registrant IP as a query result according to the above described query statements, the query processing module 103 further sends the query to the IP of the corresponding manufacturer for obtaining a required query result. The query result obtained by the user includes the attribute information of the same item for different registrant roles, which can be used by the user according to the need. In addition, the database of the manufacturer also generally provides a query interface for the system managing the item to perform the query.

As for the storage manner of using XML for storing item information, Xquery can be adopted to perform the query. The principal is the same except that the query statements are slightly different.

The query processing module 103 can also use the read device of the above mentioned information sensing device, which simplifies the input manner of the unique number of the item during the query to make the input of the query easier.

In addition, preferably, the registration information can also include the user's access permission to the related information of the item; furthermore, the specific attribute information of the item can also include the user's access permission. In this way, it can perform a permission control for the access, modification and deletion of the related information of the item; accordingly, the system for managing an item further need to include a user registration module for registering a user in the system, and the registered users have different identifications, so the permission for the query, modification and deletion of the item can also be different. In an embodiment, the user registration module receives the registration of the data source itself as a first class user, such user can be considered as a high level user, who can register the registration information of the item only after being authenticated by the data source and can also perform the access, modification and deletion for the registered information thereby. The user registration module also receives the registration from a second class user, and such user can be considered as a common user, who can only perform the query for the registration information of the item registered by the first class user, but cannot register, modify or delete the registration information of the item. Both classes of the users are also restricted by the user's access permission.

Preferably, the system for managing an item further includes a data mining module for the system for managing an item to perform a data mining in real time or periodically or in other manner to the managed item information, so as able to find a change in the content of the item information (including addition, modification, deletion) and obtain useful data information, for example, obtain some statistics information, some valuable data cube and so on. The information mined by the data mining module can be stored in the storage module 102, so that the interested user performs the query. In addition, it can also feed back some useful information found during the data mining process to the query user, making the user change his query mode, for example, the user probably never realizes that the laundry can control a washing temperature, but now many users can set their favorite washing temperature, thus the information feedback can include the query whether the user not setting the washing temperature would like to set their favorite washing temperature, and so on.

Under the same inventive concept, FIG. 4 illustrates a flowchart of a method for managing an item in the IOT according to an embodiment of the present invention. Referring to FIG. 4, the method comprises: in step S401, receiving at least one registration information of the item, wherein the registration information of the item includes the item's unique number marked by an information sensing device and a tag of an external data source where related information of the item is located, the at least one registration information is from at least one external data source, the unique number is the same in the at least one registration information; in step S402, storing the item's registration information; in step S403, receiving a query to the related information of the item; in step S404, obtaining the related information of the item from the external data source which corresponds to the external data source tag included in the stored registration information of the item. The external data source tag can be an IP address of the external data source, and can also be a link of the external data source, or any other tag to find the external data source therefrom. In this method, preferably, the item's registration information further includes: an attribute of the item stored by the external data source.

In an embodiment, before receiving the item's registration information, the method further comprises the step of authenticating an authenticity of the external data source included in the registration information of the item.

In a preferred embodiment, the received query to the related information of the item includes attribute information of the item, the obtaining the related information of the item from the external data source includes obtaining the related information of the item from the IP address of the external data source which registers the attribute information of the item based on the attribute information of the above item.

In a preferred embodiment, when receiving the registration information of the item, the unique number of the item is read through a reading means of an information sensing device. In this way, it is enabled more convenient for the user to input the item's registration information.

When storing the registration information of the item, a relationship type of database or a semi-structured XML mode can be configured to store the registration information of the item. Examples of the specific storage modes are previously given in detail, and the repeated descriptions are omitted herein.

In an embodiment, when receiving the query to the related information of the item, the unique number of the item is read through a reading means of an information sensing device. In this way, it is enabled more convenient for the user to inquire about the related information of the item.

In an embodiment, receiving the registration information of the item further comprises the steps of: receiving a registration from a first class user, wherein the first class user can register the registration information of the item, and perform an access, modification and deletion to the registered information. Preferably, receiving the query to the related information of the item further comprises the steps of: receiving a registration from a second class user, wherein the second class user can perform the query to the registration information of the item registered by the first class user. Preferably, the registration information of the item further includes the user's access permission to the item and/or the attribute information of the item. In this way, a permission control can be performed for a user's access to the item and/or the attribute information of the item.

In a preferred embodiment, after storing the registration information of the item, the method further comprises performing data mining to the managed item information, so as to obtain useful data information and feed back the obtained useful data information to the query user.

While exemplary embodiments have been described with reference to the accompanying figures, it should be appreciated that the present invention is not limited to the precise embodiments, and those of ordinary skills in the art can make various variations and modifications to the embodiments without departing from the scope and spirit of the present invention. All these variations and modifications are intended to be included within the scope of the invention defined by the appended claims.

As described above, those skilled in the art know the present invention may be embodied as a device, method or computer program product. Accordingly, the present invention may be embodied in following forms, that is, may be an entire hardware, an entire software (including firmware, resident software, microcode, etc.), or a combination of a software component and a hardware component, which are generally referred to herein as “circuit”, “module” or “system”. In addition, the present invention may also take the form of a computer program product embodied in any tangible medium of expression having a computer usable program code in the medium.

Any combination of one or more computer-usable or computer-readable medium(s) can be used. The computer-usable or computer-readable medium may be, for example, but not limited to, an electronic, magnetic, optical, electromagnetic, infrared or semiconductor system, apparatus, device or propagation medium. More specific examples (a non-exhaustive list) of the computer-readable medium include the following: an electrical connection with one or more wires, a portable computer disk, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, electrical scanning of the paper or other medium, then compiled, interpreted, or processed in a suitable manner, and stored in a computer memory if necessary. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embedded therewith, either in baseband or as part of a carrier wave. The computer-usable program code may be transmitted using any suitable medium, including, but not limited to, wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on a user's computer, as a stand-alone software package, partly on a user's computer and partly on a remote computer or entirely on a remote computer or server. In the latter scenario, the remote computer may be connected to the user's computer through any type of network, including a local area network (LAN), or a wide area network (WAN), or the connection may be made to an external computer (for example, through the Internet using an Internet Service Provider).

In addition, each block of the flowcharts and/or block diagrams of the present invention and combinations of blocks in the flowcharts and/or block diagrams, can be both implemented by computer program instructions. These computer program instructions may be provided to a processor of a general purpose computer, special purpose computer, or other programmable data processing apparatus, thereby producing a machine, such that the instructions, which execute by the computer or the other programmable data processing apparatus, create means for implementing the functions/operations specified in the block or blocks in the flowcharts and/or block diagrams.

These computer program instructions may also be stored in a computer-readable medium that can direct a computer or other programmable data processing apparatus to function in a particular manner, such that the instructions stored in the computer-readable medium produce an article of manufacture including instruction means implementing the functions/operations specified in the block or blocks in the flowcharts and/or block diagrams.

The computer program instructions may also be loaded onto a computer or other programmable data processing apparatus to cause a series of operation steps to be performed on the computer or other programmable data processing apparatus to generate a computer implemented process such that the instructions which execute on the computer or other programmable data processing apparatus provide processes for implementing the functions/operations specified in the block or blocks in the flowcharts and/or block diagrams.

The flowcharts and block diagrams in the drawings illustrate the architecture, functionality and operation of possible implementations of systems, methods and computer program products according to various embodiments of the present invention. In this regard, each block in the flowcharts or block diagrams may represent a modular, program segment, or part of code, which comprises one or more executable instructions for implementing the specified logic function(s). It should also be noted that, in some alternative implementations, the functions noted in the block may also occur in an order other than that noted in the drawings. For example, two blocks consecutively shown may, in fact, be performed substantially in parallel, or sometimes they may be performed in a reverse order, depending upon the functionality involved. It will also be noted that, each block of the block diagrams and/or flowcharts and combinations of blocks in the block diagrams and/or flowcharts, can be implemented by using a special purpose hardware-based system that executes the specified functions or operations, or by using a combination of a special purpose hardware and computer instructions.

What is claimed is:

1. A system for managing an item in the Internet of Things, comprising:
an item registration module, configured to receive at least one registration information of the item, wherein the registration information of the item includes the item's unique number marked by an information sensing device and a tag of an external data source where related information of the item is located, the at least one registration information is from at least one external data source, the unique number is the same in the at least one registration information;
a storage module, configured to store the item's registration information; and
a query processing module, configured to receive a query to the related information of the item, and obtain the related information of the item from the external data source which corresponds to the external data source tag included in the stored registration information of the item.

2. The system as claimed in claim 1, further comprising an authentication module, configured to authenticate an authenticity of the external data source included in the registration information of the item before storing the registration information of the item.

3. The system as claimed in claim 1, wherein the external data source tag is an IP address of the external data source, and the item's registration information further includes an attribute of the item stored by the external data source.

4. The system as claimed in claim 3, wherein in the query processing module, the received query to the related information of the item includes the attribute information of the item, the obtaining the related information of the item from the external data source includes obtaining the related information of the item from the IP address of the external data source which registers the attribute information of the item based on the attribute information of the above item.

5. The system as claimed in claim 1, further comprising:
a user registration module, configured to receive a registration of a first class user, wherein the first class user can register the registration information of the item, and perform access, modification and deletion to the registered information.

6. The system as claimed in claim 5, wherein the user registration module is further configured to receive a registration of a second class user, wherein the second class user can perform a query to the registration information of the item registered by the first class user.

7. The system as claimed in claim 5, wherein the registration information of the item further includes the user's access permission to the related information of the item.

8. The system as claimed in claim 1, further comprising a read means of the information sensing device, configured to receive the unique number of the item.

9. The system as claimed in claim 8, wherein the item registration module reads the unique number of the item through the read means of the information sensing device.

10. The system as claimed in claim 9, wherein the query processing module reads the unique number of the item through the read means of the information sensing device.

11. A method for managing an item in the Internet of Things, comprising:
receiving at least one registration information of the item, wherein the registration information of the item includes the item's unique number marked by an information sensing device and a tag of an external data source where related information of the item is located, the at least one registration information is from at least one external data source, the unique number is the same in the at least one registration information;
storing the item's registration information; and
receiving a query to the related information of the item;
obtaining the related information of the item from the external data source which corresponds to the external data source tag included in the stored registration information of the item.

12. The method as claimed in claim 11, wherein, authenticating an authenticity of the external data source included in the registration information of the item before storing the registration information of the item.

13. The method as claimed in claim 11, wherein the external data source tag is an IP address of the external data source, the item's registration information further includes an attribute of the item stored in the external data source.

14. The method as claimed in claim 13, wherein the received query to the related information of the item includes the attribute information of the item, the obtaining the related information of the item from the external data source includes obtaining the related information of the item from the IP address of the external data source which registers the attribute information of the item based on the attribute information of the above item.

15. The method as claimed in claim 11, before receiving the registration information of the item, further comprising:
receiving a registration of a first class user, wherein the first class user can register the registration information of the item, and perform access, modification and deletion to the registered information.

16. The method as claimed in claim 15, before receiving the query to the related information of the item, further comprising:
receiving a registration of a second class user, wherein the second class user can perform a query to the registration information of the item registered by the first class user.

17. The method as claimed in claim 15, wherein the registration information of the item further includes user's access permission to the related information of the item.

18. The method as claimed in claim 11, wherein the receiving the registration information of the item further comprising reading the unique number of the item through a read means of the information sensing device.

19. The method as claimed in claim 11, wherein receiving the query to the related information of the item further comprising reading the unique number of the item through a read means of the information sensing device.
